(19) United States
(12) Patent Application Publication
(10) Pub. No.: US 2017/0089711 A1
(43) Pub. Date: Mar. 30, 2017

(54) METHODS AND APPARATUS FOR GENERATING DIGITAL BOUNDARIES BASED ON OVERHEAD IMAGES

(71) Applicant: Faraday&Future Inc, Gardena, CA (US)

(72) Inventor: Hong S. Bae, Torrance, CA (US)

(21) Appl. No.: 15/279,157

(22) Filed: Sep. 28, 2016

Related U.S. Application Data
(60) Provisional application No. 62/235,198, filed on Sep. 30, 2015.

(51) Int. Cl. G01C 21/34; G06K 9/00; G06F 3/0484

(52) U.S. Cl. CPC G01C 21/3461; G06F 3/04842; G06K 9/0063; G01C 21/3484

(57) ABSTRACT

In one aspect, an apparatus includes a receiver configured to receive one or more images of an area and a memory configured to store the one or more images processed images. The apparatus further includes a positioning device configured to identify a position of the vehicle. The apparatus also includes a processor configured to generate one or more digital boundaries based on the one or more images or schematics, wherein the one or more digital boundaries comprise positions within which the vehicle must be maintained. The apparatus also further includes user controls configured to allow user selection of the area for which the one or more digital boundaries are to be created and manipulation of generated digital boundaries.

### INCORPORATION BY REFERENCE TO ANY PRIORITY APPLICATIONS

This application claims priority benefit of U.S. Provisional Patent Application No. 62/235,198, filed Sep. 30, 2015, the disclosure of which is herein incorporated by reference in its entirety.

### BACKGROUND

Field of the Invention

This disclosure relates to methods, systems, and apparatus of generating and identifying boundaries, and more particularly, to methods, systems, and apparatus for generating boundaries based on overhead or similar images of an area, for example as received from satellites or other types of overhead imaging systems.

Description of the Related Art

Travelers often acquire satellite or overhead images of intended destinations, for example images from GPS or navigation systems, maps, etc. Often, these images may be used to generate directions or position information. For example, images acquired from navigation or mapping systems may be used within these systems to provide directions and routes to or from a selected location. Alternatively, the system may be configured to merely provide a position or location of the user or a point of interest (POI) and/or tracking of the user, such as with a GPS system. High quality and fairly comprehensive databases of such image information and corresponding location information can be freely available over the Internet, with Google Earth being one example. Additional uses for such databases would be beneficial.

### SUMMARY

The systems, methods, and apparatus of this disclosure each have several innovative aspects, no single one of which is solely responsible for the desirable attributes disclosed herein.

One innovative aspect of the subject matter described in this disclosure can be implemented in a method of generating a boundary for a vehicle. The method comprises receiving one or more images of an area and storing the one or more images. The method further comprises processing the one or more images to generate one or more digital boundaries based on the one or more images. The processor also comprises enabling user control comprising selection of the area for which the one or more digital boundaries are created and manipulation of the one or more digital boundaries.

Another innovative aspect of the subject matter described in this disclosure can also be implemented in an apparatus. The apparatus comprises a receiver configured to receive one or more images of an area. The apparatus further comprises a memory configured to store the one or more images or processed images and a processor configured to generate one or more digital boundaries based on the one or more images. The processor also comprises controls configured to allow user selection of the area for which the one or more digital boundaries are to be created and user manipulation of the one or more digital boundaries.

Another innovative aspect of the subject matter described in this disclosure can also be implemented in another apparatus. The other apparatus comprises means for receiving one or more images of an area. The other apparatus further comprises means for storing the one or more images or processed images and means for generating one or more digital boundaries based on the one or more images. The other apparatus also comprises means for allowing user selection of the area for which the one or more digital boundaries are to be created and means for allowing user manipulation of the one or more digital boundaries.

### BRIEF DESCRIPTION OF THE DRAWINGS

The above-mentioned aspects, as well as other features, aspects, and advantages of the present technology will now be described in connection with various implementations, with reference to the accompanying drawings. The illustrated implementations, however, are merely examples and are not intended to be limiting. Throughout the drawings, similar symbols typically identify similar components, unless context dictates otherwise. Note that the relative dimensions of the following figures may not be drawn to scale.

FIG. 1 shows a diagram of an exemplary overhead image and boundary definition system.

FIG. 2 illustrates an aspect of a device or system which may perform the image processing as described in relation to FIG. 1.

FIG. 3 shows an exemplary satellite or aerial overhead image of a location of interest, as selected by a user using the device of FIG. 2.

FIG. 4 shows a zoomed in portion of the overhead image of FIG. 3.

FIG. 5 shows a zoomed in portion of the overhead image of FIG. 3 showing a digitally marked boundary.

FIG. 6 is a flowchart of a method for generating one or more digital boundaries by the device of FIG. 2 based on the overhead images as shown in FIGS. 3-5.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be configured to participate in automated driving or parking systems. More particularly, it is contemplated that the described implementations may be included in or associated with a variety of automated vehicles or similar applications such as, but not limited to: automated distribution facilities, aviation automation, and similar veins. Thus, the teachings are not intended to be limited to the implementations depicted solely in the Figures, but instead have wide applicability as will be readily apparent to one having ordinary skill in the art.

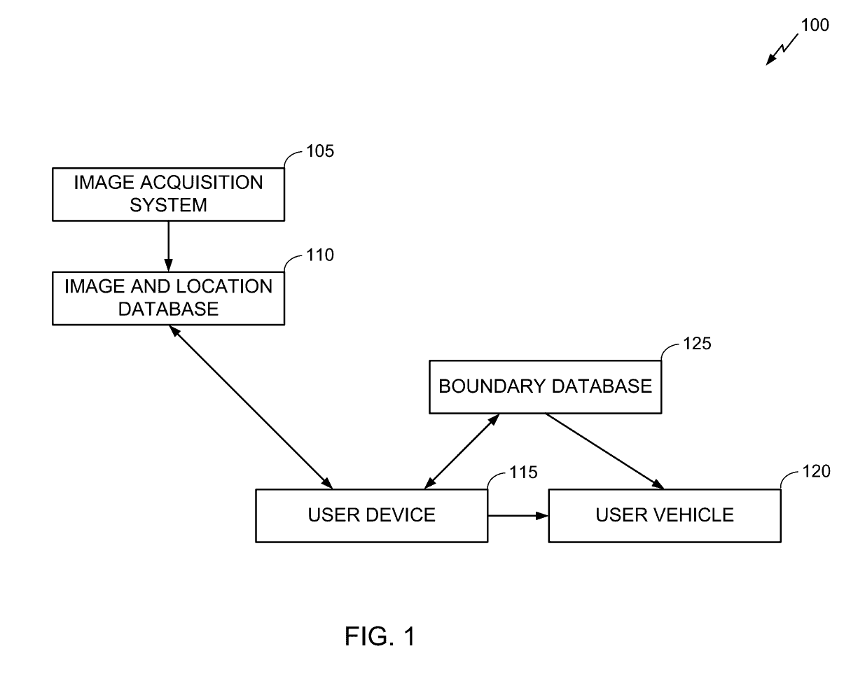

FIG. 1 shows a diagram of an exemplary system for leveraging image/location database information to assist navigation of an autonomous or semi-autonomous vehicle. In some exemplary implementations, such a system can be used in an automated parking system for a parking area. The exemplary overhead image system 100 may include a plurality of components, including an image acquisition system 105. The image acquisition system 105 may include cameras mounted one or more satellites, planes, drones, or the like for acquiring overhead image data. The image acquisition system may be public or private. The image acquisition system is used to populate an image and location database 110 which contains images as well as information about the location (e.g. latitude and longitude coordinates) of at least some image content such as structures, parks, or other geographical features as well as information about these items such as street addresses, names of roads or rivers, etc. Such databases have been created and are currently available to the public, generally free of charge, from Google, Apple, and other providers of technology services and products.

A user device 115, which may be a personal computer, smart phone, tablet computer, or the like can access the image and location database 110. The user device uses data retrieved from the image and location database 110 to define physical locations for boundaries for autonomous vehicle travel in areas of interest to the user, and may store these in a boundary database 125. Defining the boundaries with the user device 115 can be performed in an automated manner with software based image analysis, may be entirely user performed by drawing outlines on a touch screen or with another input device such as a mouse, or a combination of user interaction and software enabled automation. An autonomous or semi-autonomous vehicle 120 accesses boundaries created by the user device 115, either by receiving them from the user device 115 directly, or by accessing stored boundaries in the boundary database 125. The user device 115 may be a substantially stationary device such as a computer that is separate from the user vehicle 120 or may be a computing system integrated into the user vehicle 120 itself, or it may be a portable computing device such as a smart phone that may be separate from the vehicle 120 but at times carried along with or inside the vehicle 120.

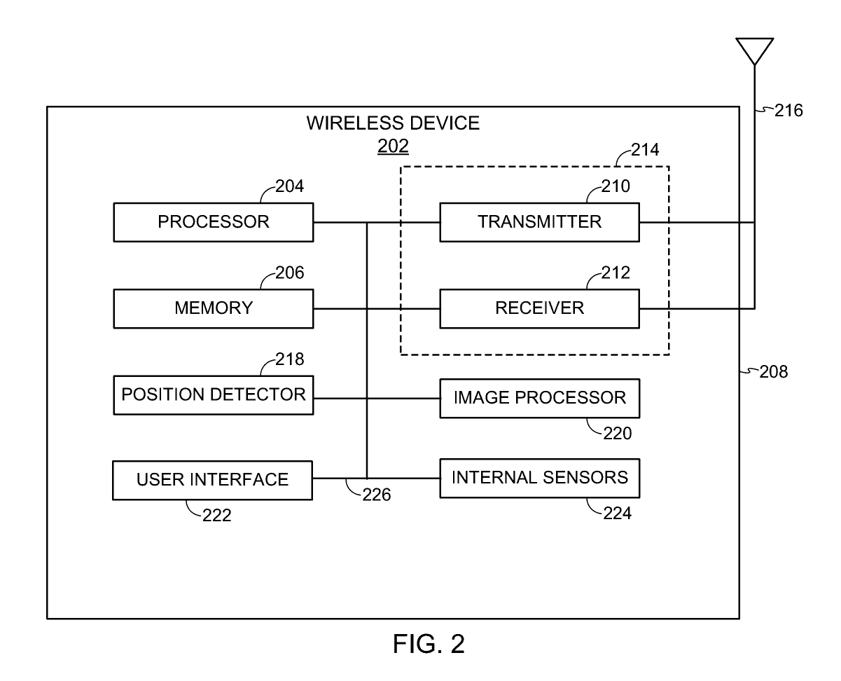

FIG. 2 illustrates an aspect of a device 202 or system which may perform the boundary definition processing as described in relation to FIG. 1, and thus may be one implementation of the user device 115 of FIG. 1. The device 202 is an example of a computing or processing device that may implement at least parts of the various methods described herein. The device 202 may include a processor 204 which controls operation of the device 202. The processor 204 may also be referred to as a central processing unit (CPU). The processor 204 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, graphics processor units (GPUs), or any other suitable entities that can perform calculations or other manipulations of information.

In some embodiments, the processor 204 may be configured to identify and process the overhead images received from the image and location database 110 (FIG. 1). Processing the images may comprise analyzing the image to identify objects and/or open spaces or regions within the image. In some embodiments, the processor 204 may only analyze pre-processed images.

Memory 206, which may include both read-only memory (ROM) and random access memory (RAM), may provide instructions and data to the processor 204. A portion of the memory 206 may also include non-volatile random access memory (NVRAM). The processor 204 typically performs logical and arithmetic operations based on program instructions stored within the memory 206. The instructions in the memory 206 may be executable to implement the methods described herein. The memory 206 may also comprise machine-readable media.

In some embodiments, the memory 206 may temporarily or permanently store received and/or processed overhead images. For example, a map database and corresponding overhead images may be stored in the memory 206 such that selection of an address or point of interest (POI) by a user or the device 202 is associated with a particular image of the memory 206. In some embodiments, the memory 206 may also comprise memory used while the received images are being processed. For example, a requested image may be stored in the memory 206 in advance of a user's selection of a point of interest or address associated with the image.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein. Accordingly, the processing system may include, e.g., hardware, firmware, and software, or any combination therein.

The device 202 may also include a housing 208 that may include a transmitter 210 and/or a receiver 212 to allow transmission and reception of data between the device 202 and a remote location or device. The transmitter 210 and receiver 212 may be combined into a transceiver 214. An antenna 216 may be attached to the housing 208 and electrically coupled to the transceiver 214 (or individually to the transmitter 210 and the receiver 212) to allow for communication between the device 202 and external devices. The device 202 may also include (not shown) multiple transmitters, multiple receivers, and/or multiple transceivers.

The transmitter 210 (or transmitter portion of the transceiver 214) can be configured to wirelessly transmit messages. The processor 204 may process messages and data to be transmitted via the transmitter 210. The transmitted information may comprise location coordinates or points of interest (user selected or processor 204 identified) that may identify overhead images requested by the device 202 from the image and location database 110. The transmitter 210 may also transmit information generated by the processor or the user, such as generated boundaries or parking information regarding a specific location (e.g., parking boundaries at a mall or other generally public area). Such transmissions by the transmitter 210 may allow generated information to be shared between other users of the automated parking system or other drivers, etc. In some embodiments, the images may be stored locally such that the transmitter 210 is not involved in communicating user entered address or POI information in a request for an image.

The receiver 212 (or the receiver portion of the transceiver 214) can be configured to wirelessly receive messages. The processor 204 may further process messages and data received via the receiver 212. In some embodiments, the receiver 212 may receive the images from one of the image location database 110 or the camera 105 (or the centralized system controller or database or another user). Accordingly, the images received may be either processed or unprocessed. When the images received are received having been processed, then the images may be sent directly to the processor for analysis.

The device 202 may also include a position detector 218 that may be used in an effort to detect a position of the device 202 or the vehicle within which the device 202 is installed. The position detector 218 may comprise a GPS locator or similar device configured to detect or determine a position of the device 202.

The device 202 may also include an image processor 220 for use in processing received overhead images. In some embodiments the functions of the image processor may be performed by the processor 204 of the device 202.

In some embodiments, processing the images by either the processor 204 or the image processor 220 may comprise performing calculations based on the image or based on identified objects or opens spaces within the image. Though only the processor 204 is described as performing the operations below, the image processor 220 may be interchanged throughout. Some embodiments may include manipulating the image, or allowing manipulation of the image by a user. For example, when used within an automated parking system, the processor 204 may receive the image. The processor 204 may then request user input regarding the image (e.g., requesting a user defined boundary, etc.). The processor 204 then processes the image by generating outer boundaries of the parking area captured by the image. For example, the processor 204 may generate a first layer on top of the image identifying parking areas as opposed to non-parking areas.

Within this first layer, the processor 204 may create a closed form area indicating the outer boundaries of the parking area. Furthermore, the processor 204 may analyze the image to identify objects within the parking area, for example curbs, walkways, trees, landscaping, other vehicles, etc. The processor 204 may further analyze the image to identify available parking locations within the parking area. In some embodiments, the processor 204 may be configured to associate one or more positions or boundaries of the parking area with a location coordinate (such as a GPS coordinate or a latitude and a longitude). The processor 204 may then save the analyzed, processed, and identified information in a database, either local to the device 202 or external to the automated vehicle.

The device 202 may further comprise a user interface 222 in some aspects. The user interface 222 may comprise a keypad, touchpad, a microphone, a speaker, and/or a display, among others. The user interface 222 may include any element or component that conveys information to a user of the device 202 and/or receives input from the user. For example, the user interface 222 may receive a user entered point of interest (for example an address of a work place or other destination). Alternatively, or additionally, the user interface 222 may provide a display of the received image(s) for viewing by the user. Such display of the user interface 222 may also provide for additional user input regarding the displayed image(s), for example focusing or zooming the displayed image(s) or allowing for the designation of boundaries or other points of interest within the image(s). The user interface 222 may also allow for the control of the automated parking process, for example activating the autopark process.

The device 202 may also comprise one or more internal sensors 224. In some aspects, the one or more internal sensors 224 may be configure to provide information to the processor 204 or any other component of the device 202. In some aspects, the one or more internal sensors 224 may include a camera, a radar, a LIDAR, an audio sensor, a proximity sensor, or inertial measurement sensors such as an accelerometer or gyro, among others. These internal sensors 224 may be configured to allow the device to monitor space around the device for obstacles or obtrusions. In some embodiments, the internal sensors 224 may be configured to identify a position of the device 202 in relation to other objects. In some embodiments, the internal sensors 224 may be used in conjunction with the image of the parking area as processed by the processor 204 above.

The various components of the device 202 may be coupled together by a bus system 226. The bus system 226 may include a data bus, for example, as well as a power bus, a control signal bus, and a status signal bus in addition to the data bus. Those of skill in the art will appreciate that the components of the device 202 may be coupled together or accept or provide inputs to each other using some other mechanism.

Although a number of separate components are illustrated in FIG. 2, those of skill in the art will recognize that one or more of the components may be combined or commonly implemented. For example, the processor 204 may be used to implement not only the functionality described above with respect to the processor 204, but also to implement the functionality described above with respect to the position detector 218 and/or the image processor 220. Further, each of the components illustrated in FIG. 2 may be implemented using a plurality of separate elements.

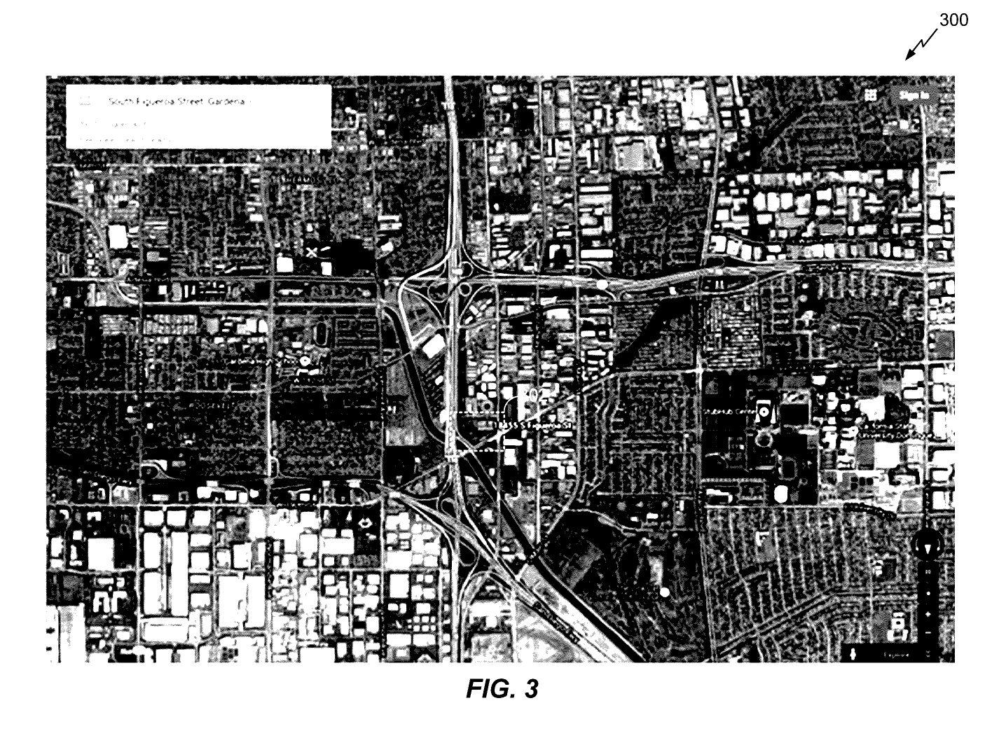

FIG. 3 shows an exemplary satellite or aerial overhead image of a location of interest, as selected by a user using the device of FIG. 2. As shown, the image 300 may display an area covered by many square blocks or miles. Alternatively, the image 300 may display a much less expansive area, instead focusing on a one or two square block area, dependent upon selection by the user, for example via the user interface 222 (FIG. 2).

In some embodiments, the device 202 may receive the image 300 based on a user input of the point of interest. Accordingly, the device 202 may display the image 300 to the user via the user interface 222, requesting the user further identify the desired location within the image. When presented with the image 300, the user may select a specific location within the image, for example the portion 302 corresponding to the address entered. In some embodiments, the processor 204, in response to receiving image 300 from the centralized controller or database, may automatically select a specific location of the based corresponding to the user identified address.

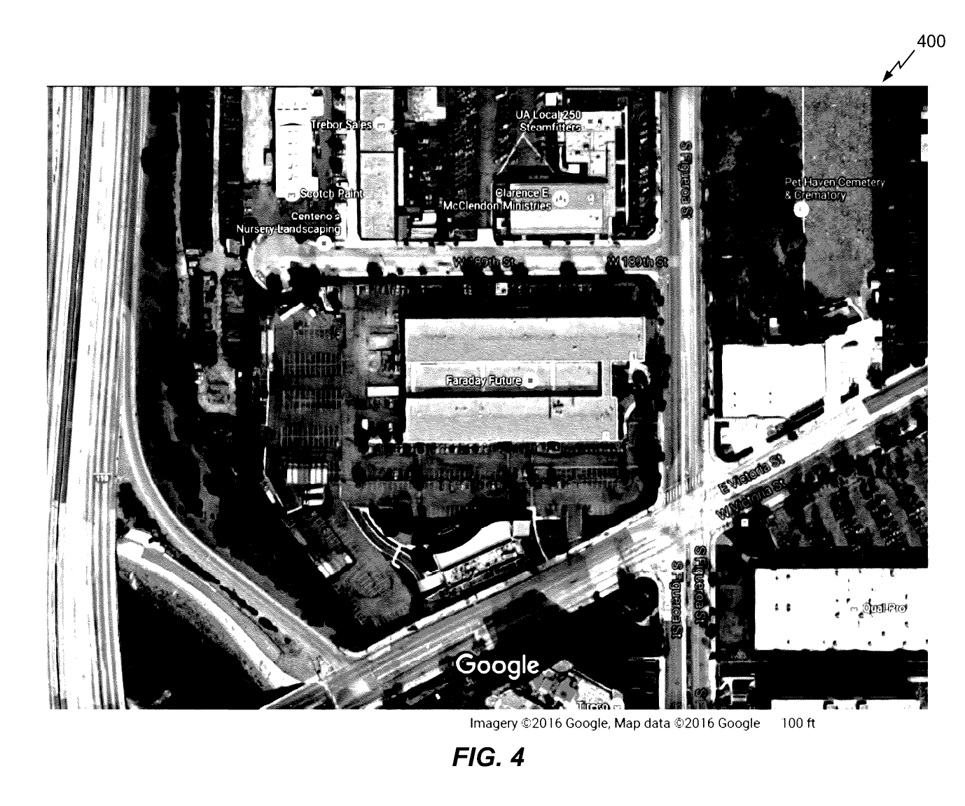

FIG. 4 shows a zoomed in portion 400 of the overhead image of FIG. 3. This image shows a building with a surrounding parking area. Such an image may be retrieved by the user device 115 by navigating through images and location information in the image and location database 110.

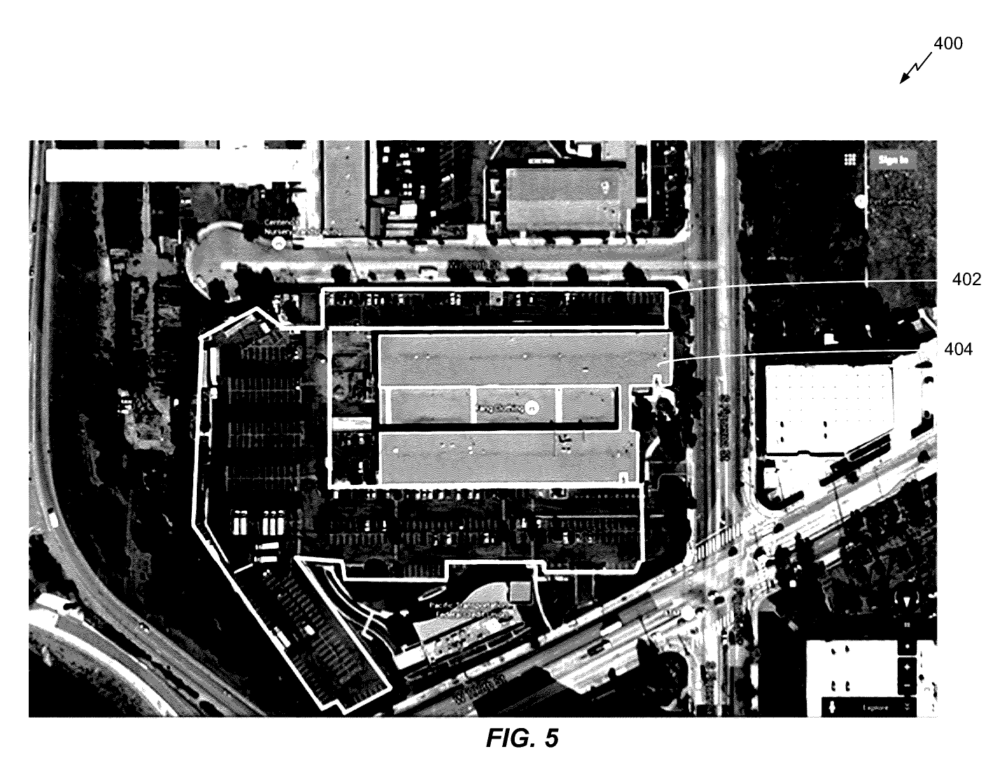

FIG. 5 shows a zoomed in portion 400 of the overhead image of FIG. 3 showing a digitally marked boundary 402 that may be used to guide an autonomous or semi-autonomous vehicle while it is in the illustrated parking area. The portion 400 also indicates the building or structure 404 located in close proximity of the parking area bordered by the digitally marked boundary 402. In some embodiments, the digitally marked boundary 402 may correspond to the processor 204 identified limits or outer boundaries of the parking area associated with the POI corresponding to the indicated location or address. In some embodiments, the digitally marked boundary 402 may be generated based on a user input that indicates the boundaries of the parking area. As shown in FIG. 4, the digitally marked boundary 402 may include a general area within which parking is allowed, although not every location (e.g., locations of trees or curbs or other landscaping) would be conducive or acceptable for parking. These other locations within the digitally marked boundary 402 may be identified by either the processor 204 or the user via user inputs.

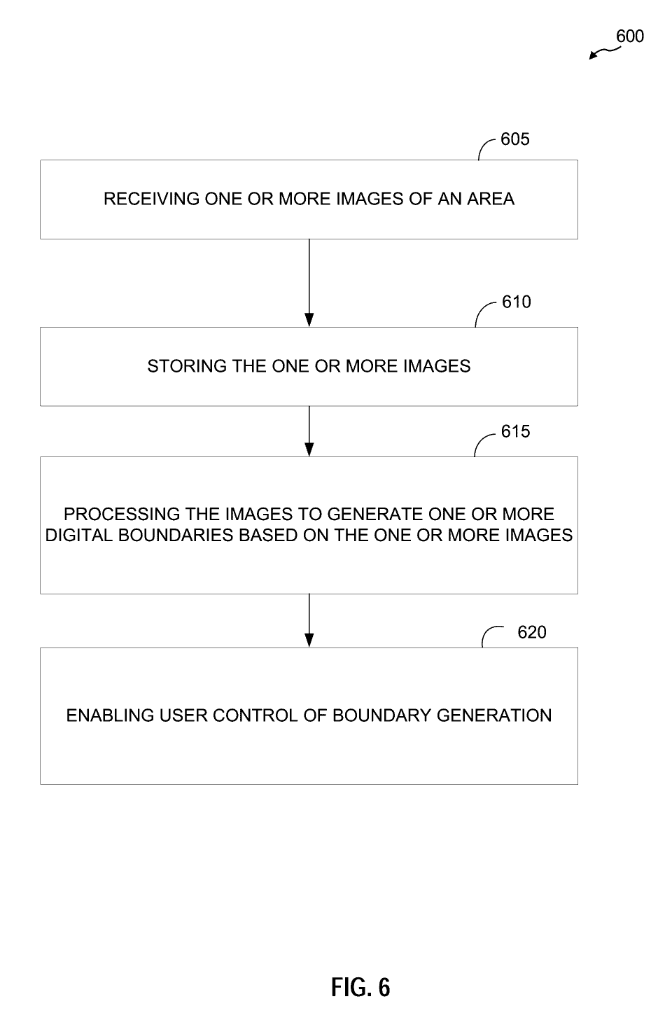

FIG. 6 is a flowchart of a method 600 for generating one or more digital boundaries by the device of FIG. 2 based on the overhead images as shown in FIGS. 3-5. In some aspects, the method 600 may be performed by the device 202, shown above with reference to FIG. 2. In some embodiments, the method 600 may be performed by an automated vehicle, an automated vehicle controller, or a software as a service provider.

The method 600 may begin with block 605, where the method 600 receives one or more images of an area. In some embodiments, the area may be a geographic area or an area associated with an address or a point of interest. In some embodiments, the method 600 receives the images from a wireless connection (for example, downloaded from a centralized database). In some embodiments, the method 600 receives the images or schematics from a local database or from a central database when the device 202 is manufactured. In some embodiments, the images or schematics may be received from a satellite or an overhead camera or other imaging system. For example, the receiving may be performed by a receiver (e.g., receiver 212 or transceiver 214 of FIG. 2) or by any other communication device or storage location. Once the method 600 receives the one or more images or schematics, the method 600 proceeds to block 610.

At block 610, the method 600 stores the one or more images or schematics. The storage of the images or schematics may be in a memory or local database. The storage may be permanent (used beyond this one access or request) or temporary (e.g., stored only during processing and associated analysis). Once the images or schematics are stored, the method 600 proceeds to block 615. At block 615, the method 600 processes the images to generate one or more digital boundaries based on the one or more images, where the one or more digital boundaries comprise positions of the one or more images within which the vehicle should be maintained. The processing of the images may be performed by the processor 204 (e.g., processor 204 of FIG. 2). The processing of the images may also be performed by the image processor 220, or by a combination of the image processor 220 and the processor 204. In some embodiments, the processing of the images may also include the user interface 222 (e.g., when the user selects one or more areas to associated with a digital boundary. Once the images have been processed to generate digital boundaries, the method 600 proceeds to block 620.

At block 620, the method 600 enables user control, wherein the user may select the area for which the one or more digital boundaries are created and/or may manipulate the generated digital boundaries. In some embodiments, the user controls 222 may enable such user control. In some embodiments, the processor 204 and/or the image processor 220 may also enable user control. In some embodiments, the method 600 may include using the generated digital boundaries to control the travel of a vehicle within an unsurveyed area.

When implemented into an automated parking system, a user of an automated vehicle may enter a point of interest (such as address of the work place or a destination for an errand or trip) in the device 202 of the automated vehicle. The device 202 may locate the entered POI in a map data base and identify a relevant overhead image. The identified image may be displayed to the user via the user interface 222. The device 202 may then provide the user with an option to manually select the outer boundaries (e.g., enable the user to draw a box around an area of interest of the image, for example via a web browser type interface) via the user interface 222.

The device 202 may process the image via the process to generate outer boundaries of available parking areas by identifying open parking areas vs. other areas (i.e., buildings, vehicles, roadways, etc.), and creates a closed form area (see digitally marked boundary 402 of FIG. 5). In some embodiments, the digitally marked boundary 402 may be formed on a separate layer of the image by the processor 204.

The processor 204 may be further configured to process the image to place inner boundaries within the digitally marked boundary based on specific locations within the general parking area where parking is not possible or permitted. For example, these specific locations may include handicap parking spots, crosswalks, trees, shrubs, etc. In some embodiments, the system may identify specific coordinates of the boundary or of the specific locations within the parking area with generally accepted location identifiers, such as GPS coordinates or latitude and longitude. Accordingly, the device 202 may save the identified information in the memory 206 or in a centralized data base (cloud-based, etc.).

An alternate general use case may involve the user entering their work address and being shown a satellite or other overhead image of that address and the immediate surrounding area. The device 202 either automatically zooms to display the immediate surrounding parking areas or the user is able to easily select the allowed parking lot by either a rough sketch or identifying boundary points via the user interface 222. The device 202 or user (for example, via user interface 222) may also identify internal areas that are not to be parked in (e.g., trees or off limit areas). The user or device 202 identified information may be stored locally (in memory 206) for either the user's personal use or moved to a shared storage area so many users may benefit from this crowd sourced parking data.

Once operational this will allow a user to, for example, map his/her work parking area once. Once the parking area is mapped, the user can then drive up to his/her work and leave his/her car at the front door gate. The car will autonomously park itself in an appropriate parking location while the user is able to perform other activities. The disclosed process insures the car will not wander off to another parking area or park in the wrong area while making it efficient to generate parking areas for multiple areas.

Similar analysis and processing of images by the device 202 may be performed for general automated transportation and driving systems, where lanes of travel, intersections, etc., may be identified by the processor 204 processing the images or by a user via a user interface 222.

The foregoing description details certain implementations of the systems, devices, and methods disclosed herein. It will be appreciated, however, that no matter how detailed the foregoing appears in text, the systems, devices, and methods can be practiced in many ways. As is also stated above, it should be noted that the use of particular terminology when describing certain features or aspects of the development should not be taken to imply that the terminology is being re-defined herein to be restricted to including any specific characteristics of the features or aspects of the technology with which that terminology is associated.

The technology is operational with numerous other general purpose or special purpose computing system environments or configurations. Examples of well-known computing systems, environments, and/or configurations that may be suitable for use with the development include, but are not limited to, personal computers, server computers, hand-held or laptop devices, multiprocessor systems, microprocessor-based systems, programmable consumer electronics, network PCs, minicomputers, mainframe computers, distributed computing environments that include any of the above systems or devices, and the like.

As used herein, instructions refer to computer-implemented steps for processing information in the system. Instructions can be implemented in software, firmware or hardware and include any type of programmed step undertaken by components of the system.

A microprocessor may be any conventional general purpose single- or multi-chip microprocessor such as a Pentium® processor, a Pentium® Pro processor, a 8051 processor, a MIPS® processor, a Power PC® processor, or an Alpha® processor. In addition, the microprocessor may be any conventional special purpose microprocessor such as a digital signal processor or a graphics processor. The microprocessor typically has conventional address lines, conventional data lines, and one or more conventional control lines.

The system may be used in connection with various operating systems such as Linux®, UNIX® or Microsoft Windows®.

The system control may be written in any conventional programming language such as C, C++, BASIC, Pascal, or Java, and ran under a conventional operating system. C, C++, BASIC, Pascal, Java, and FORTRAN are industry standard programming languages for which many commercial compilers can be used to create executable code. The system control may also be written using interpreted languages such as Perl, Python or Ruby.

Those of skill will further recognize that the various illustrative logical blocks, modules, circuits, and algorithm steps described in connection with the implementations disclosed herein may be implemented as electronic hardware, software stored on a computer readable medium and executable by a processor, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present development.

The various illustrative logical blocks, modules, and circuits described in connection with the implementations disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

The foregoing description details certain implementations of the systems, devices, and methods disclosed herein. It will be appreciated, however, that no matter how detailed the foregoing appears in text, the systems, devices, and methods can be practiced in many ways. As is also stated above, it should be noted that the use of particular terminology when describing certain features or aspects of the development should not be taken to imply that the terminology is being re-defined herein to be restricted to including any specific characteristics of the features or aspects of the technology with which that terminology is associated.

It will be appreciated by those skilled in the art that various modifications and changes may be made without departing from the scope of the described technology. Such modifications and changes are intended to fall within the scope of the implementations. It will also be appreciated by those of skill in the art that parts included in one implementation are interchangeable with other implementations; one or more parts from a depicted implementation can be included with other depicted implementations in any combination. For example, any of the various components described herein and/or depicted in the Figures may be combined, interchanged or excluded from other implementations.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity. The indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage. Any reference signs in the claims should not be construed as limiting the scope.

It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

All numbers expressing quantities of ingredients, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present development. At the very least, and not as an attempt to limit the application of the doctrine of equivalents to the scope of the claims, each numerical parameter should be construed in light of the number of significant digits and ordinary rounding approaches.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

It should be noted that the terms “couple,” “coupling,” “coupled” or other variations of the word couple as used herein may indicate either an indirect connection or a direct connection. For example, if a first component is “coupled” to a second component, the first component may be either indirectly connected to the second component or directly connected to the second component. As used herein, the term “plurality” denotes two or more. For example, a plurality of components indicates two or more components.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

In the foregoing description, specific details are given to provide a thorough understanding of the examples. However, it will be understood by one of ordinary skill in the art that the examples may be practiced without these specific details. For example, electrical components/devices may be shown in block diagrams in order not to obscure the examples in unnecessary detail. In other instances, such components, other structures and techniques may be shown in detail to further explain the examples.

It is also noted that the examples may be described as a process, which is depicted as a flowchart, a flow diagram, a finite state diagram, a structure diagram, or a block diagram. Although a flowchart may describe the operations as a sequential process, many of the operations can be performed in parallel, or concurrently, and the process can be repeated. In addition, the order of the operations may be re-arranged. A process is terminated when its operations are completed. A process may correspond to a method, a function, a procedure, a subroutine, a subprogram, etc. When a process corresponds to a software function, its termination corresponds to a return of the function to the calling function or the main function.

The previous description of the disclosed implementations is provided to enable any person skilled in the art to make or use the present disclosed process and system. Various modifications to these implementations will be readily apparent to those skilled in the art, and the generic principles defined herein may be applied to other implementations without departing from the spirit or scope of the disclosed process and system. Thus, the present disclosed process and system is not intended to be limited to the implementations shown herein but is to be accorded the widest scope consistent with the principles and novel features disclosed herein.

What is claimed is:

1. An apparatus that generates a boundary for a vehicle comprising:
a receiver configured to receive one or more images of an area;
a memory configured to store the one or more images or processed images;
a processor configured to generate one or more digital boundaries based on the one or more images; and
controls configured to allow:
user selection of the area for which the one or more digital boundaries are to be created; and
user manipulation of the one or more digital boundaries.

2. The apparatus of claim 1, wherein the processor is further configured to identify one or more portions of the area within which the vehicle may travel based on the one or more digital boundaries.

3. The apparatus of claim 1, wherein the area is a parking area.

4. The apparatus of claim 1, comprising one or more vehicle sensors configured to provide information identifying one or more objects in a vicinity of the vehicle and wherein the processor is further configured to combine the information from the one or more vehicle sensors with the one or more digital boundaries to identify a path of travel for the vehicle to follow.

5. The apparatus of claim 1, wherein the controller is further configured to:
identify one or more objects in a vicinity of the vehicle;
combine information of the one or more identified objects with the one or more digital boundaries; and
identify a path of travel for the vehicle to follow based on the combined information and one or more digital boundaries.

6. The apparatus of claim 1, comprising a transmitter configured to communicate the one or more digital boundaries or the identified path to one or more of a database or one or more other users.

7. A method of generating a boundary for a vehicle, comprising:
receiving one or more images of an area;
storing the one or more images;
processing the images to generate one or more digital boundaries based on the one or more images;
enabling user control comprising:
selection of the area for which the one or more digital boundaries are created; and
manipulation of the one or more digital boundaries.

8. The method of claim 7, wherein the receiving is performed by a receiver, the storing is performed by a memory, the processing is performed by a processor, and the user control is enabled by a user controls or interface.

9. The method of claim 7, further comprising identifying one or more portions of the area within which the vehicle may travel based on the one or more digital boundaries.

10. The method of claim 7, wherein the area is a parking area.

11. The method of claim 7, further comprising:
identifying one or more objects in a vicinity of the vehicle;
combining information of the one or more identified objects with the one or more digital boundaries; and
identifying a path of travel for the vehicle to follow based on the combined information and one or more digital boundaries.

12. The method of claim 7, further comprising communicating the one or more digital boundaries or the identified path to one or more of a database or one or more other users.

13. An apparatus for generating a boundary for a vehicle, comprising:
means for receiving one or more images of an area;
means for storing the one or more images or processed images;
means for generating one or more digital boundaries based on the one or more images; and
means for allowing user selection of the area for which the one or more digital boundaries are to be created;
means for allowing user manipulation of the one or more digital boundaries.

14. The apparatus of claim 13, wherein the means for receiving comprises a receiver, the means for storing comprises a memory, the means for generating comprises a processor, and the means for allowing user selection and manipulation comprises a user controls or interface.

15. The apparatus of claim 13, further comprising means for identifying one or more portions of the area within which the vehicle may travel based on the one or more digital boundaries.

16. The apparatus of claim 13, wherein the area is a parking area.

17. The apparatus of claim 13, further comprising:
one or more means for providing information identifying one or more objects in a vicinity of the vehicle;
means for combining the information from the one or more means for providing information with the one or more digital boundaries; and
means for identifying a path of travel for the vehicle to follow based on the information identifying one or more objects and the one or more digital boundaries.

18. The apparatus of claim 13, further comprising means for communicating the one or more digital boundaries or the identified path to one or more of a database or one or more other users.
